(19) United States
(12) Patent Application Publication
(10) Pub. No.: US 2014/0025964 A1
(43) Pub. Date: Jan. 23, 2014

(54) MOBILE TERMINAL ENCRYPTION METHOD, HARDWARE ENCRYPTION DEVICE AND MOBILE TERMINAL

(71) Applicant: HUAWEI DEVICE CO., LTD., Shenzhen (CN)

(72) Inventors: Ying HUI, Xi'an (CN); Yongquan He, Shenzhen (CN)

(73) Assignee: HUAWEI DEVICE CO., LTD., Shenzhen (CN)

(21) Appl. No.: 14/039,319

(22) Filed: Sep. 27, 2013

Related U.S. Application Data
(63) Continuation of application No. PCT/CN2012/073368, filed on Mar. 31, 2012.

(30) Foreign Application Priority Data
Mar. 31, 2011 (CN) 201110080745.X

(51) Int. Cl. G06F 21/60

(52) U.S. Cl. CPC G06F 21/602
USPC 713/193

(57) ABSTRACT

The present invention belongs to the field of mobile communications technologies and specifically discloses a mobile terminal encryption method, a hardware encryption device, and a mobile terminal, aiming to prevent a hacker from easily acquiring or tampering key data in the mobile terminal and protect the interests of a terminal manufacturer. The method in embodiments includes: performing, according to stored authentication data., authentication between the hardware encryption device and a main control chip of the mobile terminal, where the hardware encryption device stores encryption data and the authentication data; if the authentication succeeds, permitting, by the hardware encryption device, the main control chip to load the encryption data; and if the authentication fails, prohibiting, by the hardware encryption device, the main control chip from loading the encryption data. The embodiments of the present invention may be applied to a mobile terminal encryption technology and a network locking technology.

### CROSS-REFERENCE TO RELATED APPLICATIONS

This application is a continuation of International Application No. PCT/CN2012/073368, filed on Mar. 31, 2012, which claims priority to Chinese Patent Application No. 201110080745.X, filed on Mar. 31, 2011, both of which are hereby incorporated by reference in their entireties.

### TECHNICAL FIELD

The present invention belongs to the field of mobile communications technologies, and in particular, relates to a mobile terminal encryption method, a hardware encryption device, and a mobile terminal.

### BACKGROUND

At present, most encryption methods protect only data or files stored in a mobile terminal but cannot protect key data such as network locking information about mobile terminals. Therefore, after mobile terminal products are sold to different markets, board software or data may be easily acquired or tampered by a hacker.

### SUMMARY

The present invention provides a mobile terminal encryption method, a hardware encryption device, and a mobile terminal, which can prevent a hacker from easily acquiring or tampering key data in the mobile terminal.

Embodiments of the present invention adopt the following technical solutions.

A mobile terminal encryption method includes:
storing authentication data and encryption data in a hardware encryption device;
performing, according to the authentication data, authentication between the hardware encryption device and a main control chip of a mobile terminal; and
permitting, by the hardware encryption device, the main control chip to load the encryption data if the authentication succeeds; and prohibiting, by the hardware encryption device, the main control chip from loading the encryption data if the authentication fails.

A hardware encryption device includes:
a storage unit, configured to store authentication data and encryption data;
an authentication unit, configured to authenticate with a main control chip of a mobile terminal according to the authentication data stored by the storage unit; and
a control unit, configured to permit the main control chip to load the encryption data stored in the storage unit if the authentication succeeds, and prohibit the main control chip from loading the encryption data stored in the storage unit if the authentication fails.

A mobile terminal includes a main control chip and the hardware encryption device, where the main control chip is configured to authenticate with the hardware encryption device and to load the encryption data stored in the hardware encryption device after the authentication succeeds.

As can be known from the technical solutions of the preceding embodiments of the present invention, authentication data and encryption data are stored in a hardware encryption device, and authentication is performed between the hardware encryption device and with a main control chip of a mobile terminal each time the mobile terminal starts Only when the authentication succeeds, the hardware encryption device permits the main control chip to load the encryption data. Therefore, terminal manufactures and operators may save key data of the mobile terminal as encryption data in the hardware encryption device according to different requirements, and protect the key data of the mobile terminal by using a hardware encryption technology, thereby achieving the objective of preventing a hacker from easily acquiring or tampering the key data of the mobile terminal.

### BRIEF DESCRIPTION OF DRAWINGS

To illustrate the technical solutions of the present invention more clearly, the following simply introduces the accompanying drawings that are required in the description of the embodiments.

FIG. 1 is a schematic flowchart of a mobile terminal encryption method according to an embodiment of the present invention;

FIG. 2 is a schematic diagram of an authentication method according to an embodiment of the present invention;

FIG. 3 is a schematic diagram of another authentication method according to an embodiment of the present invention;

FIG. 4 is a schematic diagram of functional units of a hardware encryption device according to an embodiment of the present invention; and

FIG. 5 is a schematic structural diagram of a mobile terminal according to an embodiment of the present invention.

### DESCRIPTION OF EMBODIMENTS

For ease of understanding, the technical solutions provided in the embodiments of the present invention are hereinafter described clearly and with reference to the accompanying drawings. Evidently, the embodiments described below are only part of the embodiments, rather than all of the embodiments. All other embodiments obtained by persons of ordinary skill in the art based on the embodiments of the present invention without creative efforts shall fall within the protection scope of the present invention.

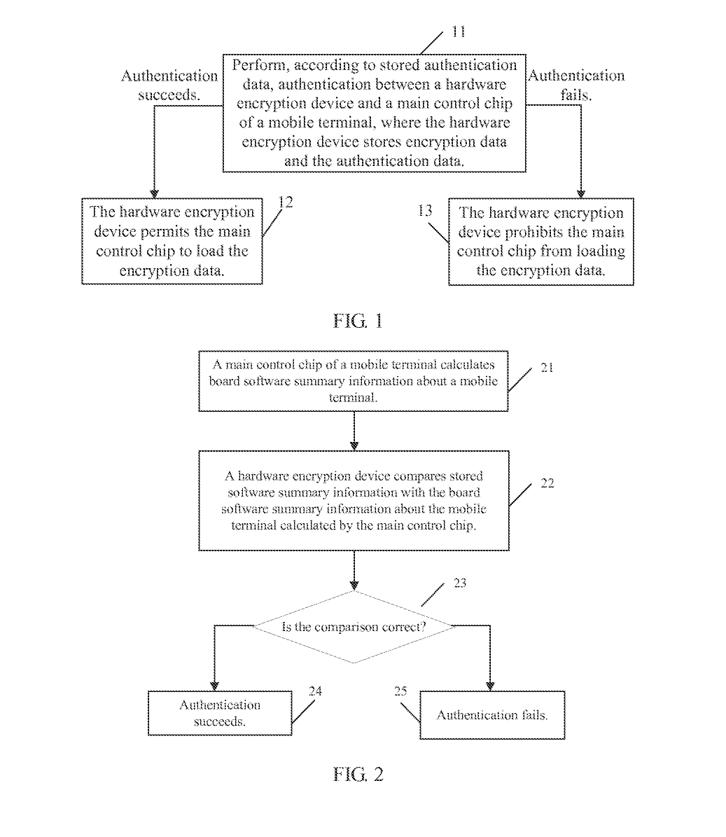

As shown in FIG. 1, an embodiment of the present invention provides a mobile terminal encryption method, including:

Step 11: Perform, according to stored authentication data, authentication between a hardware encryption device and a main control chip of a mobile terminal, where the hardware encryption device stores encryption data and the authentication data.

Step 12: If the authentication succeeds, the hardware encryption device permits the main control chip to load the encryption data.

Step 13: if the authentication fails, the hardware encryption device prohibits the main control chip from loading the encryption data.

From the preceding, it may be known that, terminal manufactures and operators may save key data of the mobile terminal as encryption data in the hardware encryption device according to different requirements, and protect the key data of the mobile terminal by using a hardware encryption technology, thereby achieving the objective of preventing a hacker from easily acquiring or tampering the key data of the mobile terminal

It should be pointed out that, the encryption data stored in the hardware encryption device may be determined according to different encryption requirements and may include but is not limited to the following information:

(1) Important program codes for implementing normal startup of the mobile terminal; when a board software of the mobile terminal is tampered, authentication between the hardware encryption device and the main control chip of the mobile terminal cannot be passed by using the authentication data stored in the hardware encryption device, and therefore, the hardware encryption device prohibits the main control chip from loading the stored important program codes, so that the mobile terminal fails to be started properly

(2) Key data for implementing normal operation of the mobile terminal, for example, NV item data for controlling configuration of a mobile terminal frequency band or radio frequency control pin configuration information; when the authentication between the hardware encryption device and the main control chip of the mobile terminal fails, the main control chip cannot load the key data for implementing normal operation of the mobile terminal, so that the mobile terminal fails to implement specific functions.

(3) Network locking segment information of operators for implementing the SIM card locking function of the mobile terminal; and when authentication between the hardware encryption device and the main control chip of the mobile terminal succeeds, the main control chip determines whether the SIM card belongs to the segment of a specific operator according to the obtained network locking segment information of operators, thereby implementing the SIM card locking function of the mobile terminal.

To implement authentication between a hardware encryption device and a main control chip of a mobile terminal, hardware encryption technologies as common sense in the prior art may be used, such as a public and private key pair technology. In an embodiment of the present invention, board software summary information about a mobile terminal is stored in the hardware encryption device. During the authentication, as shown in FIG. 2, which is a schematic diagram of an authentication method, the method includes:

Step 21: A main control chip of a mobile terminal calculates board software summary information about the mobile terminal.

Step 22: The hardware encryption device compares stored board software summary information with the board software summary information about the mobile terminal calculated by the main control chip.

Step 23: Determine whether the comparison is correct.

Step 24: If the comparison is correct, the authentication succeeds.

Step 25: If the comparison is incorrect, the authentication fails.

In the preceding authentication scheme, when the codes in hoard software of the mobile terminal are tampered, the authentication fails due to the incorrect comparison of the summary information, so that the hardware encryption device prohibits the main control chip from loading encryption data stored in the hardware encryption device, and finally the mobile terminal fails to operate normally, thereby achieving the objective of preventing a hacker from easily acquiring key data of the mobile terminal

It should be noted that, the hardware encryption device may authenticate with the main control chip of the mobile terminal each time when the main control chip starts or when the main control chip needs to use a certain function, for example, each time when the mobile terminal is connected to a network. In addition, the authentication may be performed once or multiple times.

In an embodiment of the present invention, to further improve a security encryption level and anti-crack difficulty, an encryption level is set for the encryption data in the hardware encryption device. During the authentication, as shown in FIG. 3, which is a schematic diagram of an authentication method, the method includes:

Step 31: Perform authentication between a hardware encryption device and a main control chip of a mobile terminal level by level.

Step 32: Determine whether authentication of the corresponding level is successful.

Step 33: The hardware encryption device permits the main control chip to load only the encryption data of the corresponding level after the authentication of each level succeeds, and permits the main control chip to load all the encryption data until the authentication of all levels is passed, thereby implementing normal startup or normal operation of the mobile terminal.

Step 34: When the authentication of any level fails, the main control chip restarts, and the hardware encryption device continues to authenticate with the main control chip. When the number of failure times reaches a specified number, exception handling begins.

In another embodiment of the present invention, to further improve the security encryption level and anti-crack difficulty, a software encryption technology is used to encrypt encryption data stored in a hardware encryption device. In this way, even if a hacker cracks the encryption data stored in the hardware encryption device, the encryption data encrypted by using the software encryption technology may be used only after being further decrypted by the main control chip, thereby achieving the objective of preventing the hacker from easily acquiring the key data of the mobile terminal.

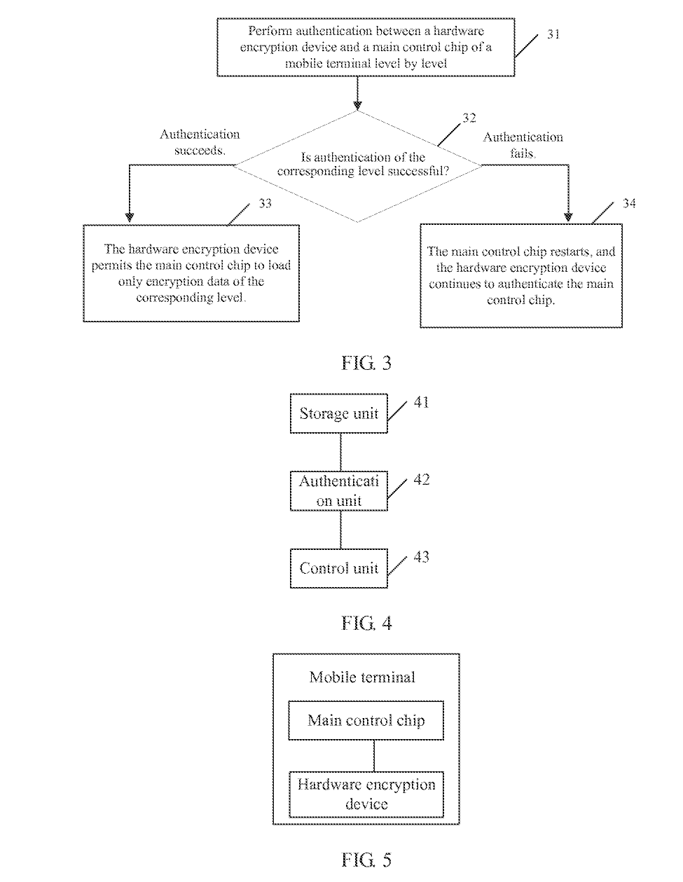

As shown in FIG. 4, an embodiment of the present invention provides a hardware encryption device, including:
a storage unit 41, configured to store authentication data and encryption data;
an authentication unit 42, configured to authenticate with a main control chip of a mobile terminal according to the authentication data stored by the storage unit 41; and
a control unit 43, configured to permit the main control chip to load the encryption data stored in the storage unit 41 if the authentication succeeds, and prohibit the main control chip from loading the encryption data stored in the storage unit 41 if the authentication fails.

The encryption data stored in the storage unit 41 includes but is not limited to one or more of the following: important program codes for implementing normal startup of the mobile terminal; and/or key data for implementing normal operation of the mobile terminal; and/or network locking segment information of operators for implementing the SIM card locking function of the mobile terminal.

For example, the encryption data may be NV item data for controlling configuration of a mobile terminal frequency band or radio frequency control pin configuration information; and when the authentication between the hardware encryption device and the main control chip of the mobile terminal fails, the main control chip cannot load the key data. for implementing normal operation of the mobile terminal, so that the mobile terminal fails to implement specific functions.

For another example, the encryption data may be the network locking segment information of operators; and when authentication between the hardware encryption device and the main control chip of the mobile terminal succeeds, the main control chip determines whether a SIM card belongs to the segment of a specific operator according to the obtained network locking segment information of operators, thereby implementing the SIM card locking function of the mobile terminal

In an embodiment, to implement authentication between the hardware encryption device and the main control chip of the mobile terminal, the authentication data stored in the storage unit 41 includes: board software summary information about the mobile terminal; at this time, the authentication unit 42 is specifically configured to compare board software summary information stored in the storage unit 41 with the board software summary information about the mobile terminal calculated by the main control chip of the mobile terminal; and determine the authentication succeeds if the comparison is correct, and determine the authentication fails if the comparison is incorrect. In this way, when codes in board software of the mobile terminal are tampered, the authentication fails due to incorrect comparison of summary information, and the control unit 43 prohibits the main control chip from loading the encryption data stored in the hardware encryption device, and finally the mobile terminal fails to operate normally.

In an embodiment, to further improve the security encryption level and anti-crack difficulty, an encryption level is set for the encryption data stored in the storage unit; and the control unit 43 is specifically configured to permit the main control chip to load the encryption data of the corresponding level after the authentication of each level succeeds, and permit the main control chip to load all the encryption data until the authentication of all levels succeeds.

In another embodiment, to further improve the security encryption level and anti-crack difficulty, a software encryption technology is used to encrypt the encryption data stored in the storage unit 41. In this way, even if a hacker cracks the encryption data stored in the hardware encryption device, the encryption data encrypted by using the software encryption technology may be used only after being further decrypted by the main control chip, thereby achieving the objective of preventing the hacker from easily acquiring the key data of the mobile terminal.

As shown in the preceding embodiments of the present invention, the hardware encryption device stores the authentication data. and encryption data through the storage unit 41, and authenticates with the main control chip of the mobile terminal through the authentication unit 42. Only when the authentication succeeds, the control unit 43 permits the main control chip to load the encryption data. Therefore, terminal manufactures and operators may save key data of the mobile terminal as encryption data in the hardware encryption device according to different requirements, and protect the key data of the mobile terminal by using the hardware encryption technology, thereby achieving the objective of preventing a hacker from easily acquiring or tampering the key data. of the mobile terminal.

As shown in FIG. 5, an embodiment of the present invention provides a mobile terminal, including: a main control chip and a hardware encryption device, where the main control chip is configured to authenticate with the hardware encryption device and to load encryption data stored in the hardware encryption device after the authentication succeeds, which are not described anymore herein.

The mobile terminal encryption method, the hardware encryption device, and the mobile terminal provided by the embodiments of the present invention may he used in a mobile terminal encryption technology and a network locking technology

The preceding descriptions are merely specific implementation manners of the present invention, but are not intended to limit the protection scope of the present invention. Any variation or replacement readily figured out by a person skilled in the art within the technical scope disclosed in the present invention shall fall within the protection scope of the present invention. Therefore, the protection scope of the present invention shall be subject to the protection scope of the claims.

What is claimed is:

1. A mobile terminal encryption method, comprising:
performing, according to stored authentication data, authentication between a hardware encryption device and a main control chip of a mobile terminal, wherein the hardware encryption device stores encryption data and the authentication data; and
permitting, by the hardware encryption device, the main control chip to load the encryption data if the authentication succeeds; and prohibiting, by the hardware encryption device, the main control chip from loading the encryption data if the authentication fails.

2. The method according to claim 1, wherein the encryption data comprises but is not limited to one or more of the following:
important program codes for implementing normal startup of the mobile terminal;
key data for implementing normal operation of the mobile terminal; and
network locking segment information of operators for implementing a SIM card locking function of the mobile terminal.

3. The method according to claim 1, wherein the authentication data comprises board software summary information about the mobile terminal; and
the performing, according to stored authentication data, authentication between a hardware encryption device and a main control chip of a mobile terminal comprises:
comparing, by the hardware encryption device, stored board software summary information with the board software summary information about the mobile terminal calculated by the main control chip; and
determining the authentication succeeds if the comparison is correct, and determining the authentication fails if the comparison is incorrect.

4. The method according to claim 1, further comprising: setting an encryption level for the encryption data;
the permitting, by the hardware encryption device, the main control chip to load the encryption data if the authentication succeeds comprises:
after the authentication of each level succeeds, permitting, by the hardware encryption device, the main control chip to load the encryption data of the corresponding level; and until the authentication of all levels succeeds, permitting, by the hardware encryption device, the main control chip to load all the encryption data.

5. The method according to claim 2, farther comprising: setting an encryption level for the encryption data;
the permitting, by the hardware encryption device, the main control chip to load the encryption data if the authentication succeeds comprises:
after the authentication of each level succeeds, permitting, by the hardware encryption device, the main control chip to load the encryption data of the corresponding level; and until the authentication of all levels succeeds, permitting, by the hardware encryption device, the main control chip to load all the encryption data.

6. The method according to claim 1, further comprising:
encrypting the encryption data by using a software encryption technology

7. The method according to claim 2, further comprising:
encrypting the encryption data by using a software encryption technology

8. A hardware encryption device, comprising:
a storage unit, configured to store authentication data and encryption data;
an authentication unit, configured to authenticate with a main control chip of a mobile terminal according to the authentication data. stored by the storage unit; and
a control unit, configured to permit the main control chip to load the encryption data stored in the storage unit if the authentication succeeds, and prohibit the main control chip from loading the encryption data stored in the storage unit if the authentication fails.

9. The hardware encryption device according to claim 6, wherein the encryption data stored in the storage unit comprises but is not limited to one or more of the following:
important program codes for implementing normal startup of the mobile terminal: and/or key data for implementing normal operation of the mobile terminal; and/or network locking segment information of operators for implementing a SIM card locking function of the mobile terminal,

10. The hardware encryption device according to claim 8, wherein the authentication data stored in the storage unit comprises: board software summary information about the mobile terminal; and
the authentication unit is specifically configured to compare board software summary information stored in the storage unit with the board software summary information about the mobile terminal calculated by the main control chip of the mobile terminal; and determine the authentication succeeds if the comparison is correct, and determine the authentication fails if the comparison is incorrect.

11. The hardware encryption device according to claim 9, wherein
the authentication data stored in the storage unit comprises: board software summary information about the mobile terminal; and
the authentication unit is specifically configured to compare board software summary information stored in the storage unit with the board software summary information about the mobile terminal calculated by the main control chip of the mobile terminal; and determine the authentication succeeds if the comparison is correct, and determine the authentication fails if the comparison is incorrect.

12. The hardware encryption device according to claim 8, wherein
an encryption level is set for the encryption data stored in the storage unit; and
the control unit is specifically configured to permit the main control chip to load the encryption data of the corresponding level after the authentication of each level succeeds, and permit the main control chip to load all the encryption data until the authentication of all levels succeeds,

13. The hardware encryption device according to claim 9, wherein
an encryption level is set for the encryption data stored in the storage unit; and
the control unit is specifically configured to permit the main control chip to load the encryption data. of the corresponding level after the authentication of each level succeeds, and permit the main control chip to load all the encryption data until the authentication of all levels succeeds.

14. The hardware encryption device according to claim 8, wherein
the encryption data stored in the storage unit is encrypted by using a software encryption technology.

15. The hardware encryption device according to claim 9, wherein
the encryption data stored in the storage unit is encrypted by using a software encryption technology.

16. A mobile terminal, comprising the main control chip and the hardware encryption device according to claim 8, wherein the main control chip is configured to authenticate with the hardware encryption device and to load the encryption data stored in the hardware encryption device after the authentication succeeds.

17. A mobile terminal, comprising the main control chip and the hardware encryption device according to claim 9, wherein the main control chip is configured to authenticate with the hardware encryption device and to load the encryption data stored in the hardware encryption device after the authentication succeeds.
